(19) United States
(12) Patent Application Publication
(10) Pub. No.: US 2025/0019595 A1
(43) Pub. Date: Jan. 16, 2025

(54) PROCESS TO CONTINUOUSLY PREPARE A GAS OIL PRODUCT

(71) Applicant: Raymond Paul FLETCHER, Amsterdam (NL)

(72) Inventor: Raymond Paul FLETCHER, Amsterdam (NL)

(21) Appl. No.: 18/710,351

(22) PCT Filed: Nov. 15, 2022
(86) PCT No.: PCT/EP2022/081960

§ 371 Date: May 15, 2024

Related U.S. Application Data
(60) Provisional application No. 63/279,769, filed on Nov. 16, 2021.

(30) Foreign Application Priority Data
Dec. 22, 2021 (EP) 21216808.2

(51) Int. Cl. C10G 1/06; C10G 1/00; C10G 1/02

(52) U.S. Cl. CPC C10G 1/06; C10G 1/006; C10G 1/02; C10G 2300/1014; C10G 2300/202; C10G 2300/301; C10G 2300/302; C10G 2300/307; C10G 2300/4006; C10G 2300/4012; C10G 2400/06

(57) ABSTRACT

The invention is directed to a process to continuously prepare a gas oil product from carbonaceous particles of a biomass source comprising the following steps. (a) contacting carbonaceous particles with a hydrogen comprising gas in a fluidised bed reactor in the absence of oxygen and in the absence of a catalyst, at an average solids residence time of between (20) and (120) seconds and at thermal conversion conditions to obtain a gaseous mixture comprising of hydrocarbons and char particles. (b) discharging the char particles and the gaseous mixture separately from the fluidised bed reactor. And (c) isolating from the gaseous mixture a gas oil product by means of distillation.

The invention is directed to a process to continuously prepare a gas oil product from carbonaceous particles of a biomass source by converting the carbonaceous particles at thermal conversion conditions to a gaseous mixture comprising of hydrocarbons isolating from the gaseous mixture a gas oil product by means of distillation.

WO91/11499 describes in its introductory part that historically pyrolysis of carbonaceous materials was performed by so called slow pyrolysis which yielded roughly equal proportions of non-reactive solids, like char and ash, liquid products and non-condensable gases. It was found that fast pyrolysis yielded more valuable chemicals and fuels at the expense of the undesirable slow pyrolysis products. The fast pyrolysis is described to take place at a temperature between 350 and 800 C at a solids residence time of between 30 ms to 2 seconds. The reaction products are reduced to a temperature below 350° C. within 0.5 seconds. Various reactors are described such as a fluidised bed reactor. It is mentioned that in such a reactor the short solid residence time for fast pyrolysis cannot be achieved. Vacuum pyrolysis is mentioned as advantageous to achieve a high liquid products yield. However vacuum pyrolysis is described to be disadvantageous because of heat transfer limitations, difficulty associated with scale up of vacuum processes and the potential of inadequate solids flow. The proposed process of this publication involves a vertical entrained bed transport reactor where the solid carbonaceous feed contacts a recirculating solid heat carrier. The recirculating heat carrier is isolated from the reaction products and separately reheated before being contacted with fresh feedstock.

More recent publications like for example WO2012/115754 describe a similar fast pyrolysis process involving a circulating heat carrier, which may be sand particles. The illustrated process involves a reheater where pyrolysis char is combusted to directly heat the heat carrier.

A disadvantage of such non-catalytic pyrolysis processes is that the quality of the gas oil product is not sufficient for use as a transportation fuel or as a blending component for a transportation fuel.

US2019/0153324 describes a pyrolysis process as performed in the presence of a fluidized catalyst, such as a sulphided cobalt-molybdenum catalyst and in the presence of a hydrogen containing gas. A disadvantage of this process is the use of a sulphided catalyst. For one the catalyst requires to be sulphided in a separate reactor. Further the catalyst requires metals which make the catalyst complex when compared to a typical FCC catalyst. Further the metals may end up in the gas oil product and fresh catalyst is required to be added in larger quantities to compensate for the loss of catalyst.

The aim is to provide a process to convert carbonaceous particles of a biomass source to a gas oil product having an improved quality.

This aim is achieved by the following process. Process to continuously prepare a gas oil product from carbonaceous particles of a biomass source comprising the following steps,
contacting carbonaceous particles with a hydrogen comprising gas in a fluidised bed reactor in the absence of oxygen and in the absence of a catalyst, at an average solids residence time of between 20 and 120 seconds and at thermal conversion conditions to obtain a gaseous mixture comprising of hydrocarbons and char particles,
discharging the char particles and the gaseous mixture separately from the fluidised bed reactor, and
isolating from the gaseous mixture a gas oil product by means of distillation.

The applicant found that by performing the pyrolysis as a slow pyrolysis and in the presence of hydrogen a higher quality gas oil product is obtained. Further char particles may be obtained as a secondary product. This because the char is not necessarily required to be combusted to provide for the required heat to conduct the pyrolysis reaction as in the prior art processes. This is advantageous because the char can then be used as a fertiliser, a filter component, or as a source of graphene. Char is valuable as a fertilizer in that the minerals present in the char can be recycled to the soil for growing fresh biomass. Further advantages will become apparent when discussing the invention in more detail below.

The carbonaceous particles of a biomass source may be particles of wood, forestry residues, or fibrous biomass such as agricultural residues, such as for example, corn residues, straw, wheat residues, rice residues, switchgrass & other fibrous biomass. Further sources may be green urban waste, cotton gin residue, any type of wood, for example palm fronds, cedar, mesquite, oak, spruce, poplar, willow, and bamboo, wood harvesting residue, like for example limbs, stumps and roots, animal waste, like manure, wood waste, cardboard, construction debris, demolition debris, railroad ties, used pallets, furniture waste and municipal waste.

The preferred solids residence time will depend on the type of biomass. Preferred residence time for carbonaceous particles of a wood biomass is between 100 and 120 seconds. For less woody biomass, like for example straw, corn, rice and cotton residues, the optimal solid residence time is suitably lower and in the range of 20 to 100 seconds.

The size of the carbonaceous particles may be expressed in its largest and smallest dimension. Preferably more than 90 wt % of the particles have a smallest dimension of above 0.3, preferably above 0.5 cm and a largest dimension of smaller than 2.5 and preferably smaller than 1.3 cm.

The particles may be chips, pellets, or shredded vegetable waste such as wood pellets.

The thermal conversion conditions are suitably achieved by contacting the carbonaceous particles with a hydrogen comprising gas at a temperature of between 50° and 1100° C. and preferably between 80° and 1050° C. The temperature may be achieved by any means such as indirect heat exchange or by using a solid heat carrier. Preferably the temperature conditions are achieved by contacting the carbonaceous particles with a hydrogen comprising gas having an elevated temperature of suitably between 100° and 1500° C. Using a heated hydrogen comprising gas instead of a solid heat carrier is advantageous because it avoids having to recirculate and heat up the solid heat carrier. Such a recirculation and heating of solids is more complex than having to increase the temperature of a gas, such as a hydrogen comprising gas.

Step (a) is performed in the absence of added catalysts and more preferred in the absence of a heterogeneous catalyst as for example described in US2019/0153324 which are porous heterogeneous catalysts onto which one or more metals of Group 6, Group 9 or Group 10 of the Table of Elements are incorporated.

The hydrogen comprising gas suitably has a hydrogen content of above 25 vol. % and preferably between 50 and 75 vol. %. Other gaseous compounds which may be present in the hydrogen comprising gas are nitrogen, methane, carbon dioxide, carbon monoxide. The hydrogen comprising gas will not comprise any significant amounts of oxygen. Any oxygen ingress into the hydrogen comprising gas will almost immediately react with hydrogen at the elevated temperature conditions.

The hydrogen comprising gas will consist of the hydrogen comprising gas as separated from the gaseous mixture and make-up hydrogen. Make-up hydrogen is required because part of the hydrogen will react with the biomass and especially the oxygenated compounds in the biomass and olefins in the reaction products. Make-up hydrogen may for example be prepared by gasification of the residue as isolated from the gaseous mixture. The syngas as obtained in such a gasification may be subjected to a water gas shift reaction to obtain the required make-up hydrogen and carbon dioxide.

The hydrogen may also be generated using the carbon monoxide present in the fuel gas by performing a water gas shift reaction. This may be performed in a Water Gas Shift Reactor (WGSR). Hydrogen may also be prepared in for example a Steam Methane Reforming reactor or a Solid Oxide Electrolysis Cell (SOEC) processing water.

The pressure at which the pyrolysis is performed may range from 0.7 to 35 kPa. It has been found that the best quality gas oil product is prepared when the pressure is near vacuum. Suitably the pressure is between 3.0 kPa and 13.7 kPa.

The fluidised bed reactor suitably comprises a bubbling fluidising bed of the carbonaceous particles to which fluidising bed the hydrogen comprising gas is supplied to the fluidising bed as a fluidising gas and from which fluidising bed the gaseous mixture is discharged upwardly and away from the fluidising bed. The fluidising particles will in a continuous process be a mixture of the carbonaceous particles and the char particles.

The hydrogen comprising gas is supplied to the fluidising bed at a velocity of suitably more than 0.25 m/s and preferably between 1 and 2 m/s. Preferably the gravitational force on the particles is in counterbalance with the drag force of the upwardly flowing hydrogen comprising gas. The gas velocity at which this happens is referred to as the incipient fluidization velocity. The process is thus preferably performed gas just above the incipient fluidization velocity. In this way less of the particles are entrained with the gas. Any such entrained particles are preferably separated from the gaseous mixture which is discharged upwardly by means of one or more cyclones. Such cyclones may suitably be positioned in the upper part of such a vessel. In this way the separated particles can be easily returned to the fluidised bed of particles.

The hydrogen comprising gas may be supplied to the fluidised bed reactor via a perforated plate or a perforated dome and more preferably via a gas distribution pipe grid that extends across the cross-sectional area of the reactor. Such inlet systems are well known in the field of fluidisation.

The carbonaceous particles of a biomass source may be supplied to the bubbling fluidised bed reactor via a supply conduit preferably by means of gravity and pressure. Preferably the supply of carbonaceous particles is performed continuously.

The char particles and the gaseous mixture are separately discharged from the bubbling fluidised bed reactor. The gaseous mixture is suitably discharged at the upper end of the bubbling fluidised bed reactor, optionally via one or more cyclones. The char particles may be removed by discharging part of the fluidised particles from the bubbling fluidised bed. This may be achieved by for example a non-symmetrical collection hopper below an optional hydrogen distribution grid to prevent bridging of the char or via an overflow well permanently fixed above the hydrogen distribution grid in order to control bed depth. The overflow pipe may be in the shape of a non-symmetrical hopper.

The char particles as discharged are suitably cooled. Preferably the cooling is performed by means of an indirect heat exchange. Suitably the cooling medium is evaporating boiler feed water. Any entrained gasses are separated from the cooled char particles, suitably by means of a cyclone. The separated gasses may be combined with the overhead gas as described below.

From the gaseous mixture any entrained particles are removed, preferably by means of a cyclone, preferably two cyclones in series. In a bubbling bed reactor more than one of such series of cyclones may be present and suspended from the roof of the reactor vessel. The hot gaseous mixture is preferably reduced in temperature by quenching. Preferably the quenching is performed by contacting the gaseous mixture with a liquid mixture of hydrocarbons having a lower temperature than the gaseous mixture resulting in a gaseous mixture reduced in temperature and a rich quench liquid. Part of the higher boiling compounds in the gaseous mixture will condense in the quenching step and become part of the rich quench liquid. The liquid mixture of hydrocarbons preferably has a boiling range boiling predominantly above the boiling range of the gas oil product. Preferably the liquid mixture of hydrocarbons boil for more than 90 wt. % above 260° C. The temperature of the liquid mixture of hydrocarbons to be used in the quenching step is suitably at least 150° C., preferably at least 300° C., lower than the temperature of the rich quench liquid.

The rich quench liquid is suitably reduced in temperature and partly reused as the liquid mixture of hydrocarbons in the quench step. Another part is discharged as a residue product of the process.

The quenching step is preferably performed in a counter-current operated process step where the gaseous mixture flows upward and the liquid mixture of hydrocarbons flows downwardly. Preferably the counter-current gas-liquid contacting is enhanced by performing the contacting in a packed bed or on one or more distillation trays. Examples of possible distillation trays are bubble cap trays, sieve deck trays, dual flow trays, valve trays and baffle trays.

Step (c) is suitably performed by means of vacuum distillation wherein a residue stream is discharged at a lower end of a vacuum operated distillation column and an overhead stream is discharged at an upper end of the vacuum operated distillation column. The vacuum distillation is suitably performed at an absolute pressure of between 0.7 and 145 kPa. The overhead stream is cooled such that substantially the hydrocarbons boiling in the gas oil range and above condense and the hydrocarbons boiling below the gas oil range remain gaseous. By performing a gas-liquid separation an overhead gas comprising hydrogen, fuel gas compounds and a naphtha fraction and a liquid gas oil fraction is obtained. Part of the liquid gas oil fraction is returned as a reflux stream to the vacuum distillation column and part of the liquid gas oil fraction is obtained as the gas oil product. Preferably a further part of the liquid gas oil fraction is used in admixture with the residue to quench the gaseous mixture having an elevated temperature as it is discharged from the fluidised bed reactor.

The overhead gas comprising hydrogen, fuel gas compounds and a naphtha fraction is suitably compressed and separated into a hydrogen rich fraction, a fuel gas, naphtha fraction and a water fraction. The hydrogen rich fraction is suitably used as the hydrogen comprising gas in the fluidised bed reactor. The fuel gas is preferably used as fuel in a furnace to heat up the hydrogen comprising gas. The naphtha fraction may be discharged as a separate product of this process and may find use as a fuel blending component or as a feed for a process to prepare chemicals such as lower olefins.

The quenching step is preferably performed in a lower part of the vacuum operated distillation column. In such a preferred operation the afore mentioned packed bed or distillation trays are present in the lower part of the vacuum operated distillation column. The rich quench liquid is discharged from the vacuum operated distillation column at an elevation below the packed bed or distillation trays of the quenching step.

The gas oil product obtainable with the process according to this invention has a distillation curve which is for more than 80 wt % between 25° and 300° C., a T90 wt percent of between 280-350° C., a density of between about 0.76 and 0.85 g/cm at 15 degrees centigrade, a cetane number greater than 40, a sulphur content of less than 100 ppmw, a viscosity between about 1.9 and 4.1 centistokes at 40° C. and an aromatics content of no greater than 15 wt percent. Such a gas oil product may be used as part of a transportation fuel.

The invention will be illustrated by the following Figures.

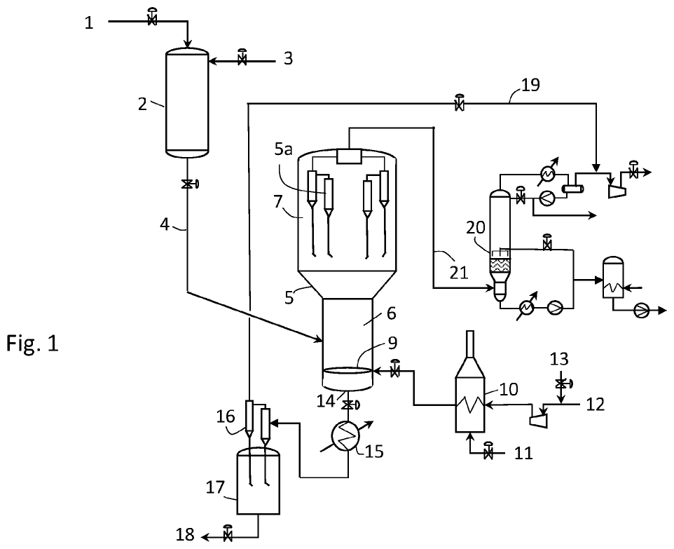

FIG. 1 shows a process scheme for performing the process according to this invention. Via flow (1) carbonaceous particles of a biomass source are provided to a lock hopper vessel (2). To this vessel (2) nitrogen is supplied via flow (3) to replace any air present in the particles. The carbonaceous particles are supplied to a fluidised bed reactor (5) via conduit (4). The fluidised bed (5) has a lower part (6) and an upper part (7) having a larger diameter than the lower part. In the lower part (6) a bubbling fluidised bed of particles is present. The wider diameter of the upper part (7) will avoid entrainment of particles with the gaseous mixture which is discharged from the bubbling bed of particles. A hydrogen comprising gas is supplied to the fluidised bed via a gas distribution pipe grid (9). The hydrogen comprising gas is heated in a furnace (10) using a fuel gas (11). The fuel gas (11) is preferably isolated from the gaseous overhead stream of the vacuum distillation column (20). The hydrogen comprising gas is made up of hydrogen comprising gas (12) as isolated from the gaseous overhead stream of the vacuum distillation column (20) and make up hydrogen (13).

Char particles are discharged from the fluidised bed reactor (5) at a char particles outlet (14). The hot char particles are cooled in heat exchanger (15) against evaporating boiler feed water generating steam. Any entrained gasses are separated from the cooled char particles in two cyclones (16) wherein the char particles are collected in char collection vessel (17) and discharged as a separate char product (18). The separated gasses are combined with the gaseous overhead stream of the vacuum distillation column (20) via flow (19).

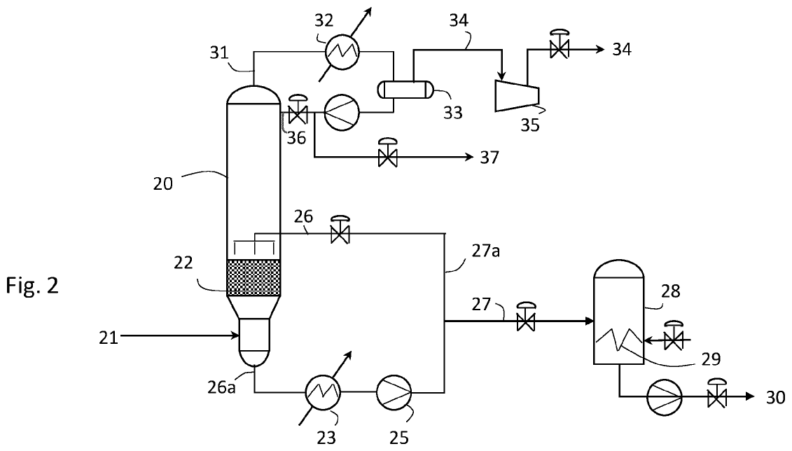

The gaseous mixture is discharged from the fluidised bed reactor (5) via two or more cyclones in series (5a) as present in the upper dome of the reactor vessel of the fluidised bed reactor (5). The separated particles are returned to the fluidised bed in the lower part (6). The gaseous mixture (21) depleted of any entrained particles is supplied to the lower end of a vacuum distillation column (20) which will be described in more detail in FIG. 2.

FIG. 2 shows the vacuum distillation column (20) of FIG. 1. To the lower end of the vacuum distillation column (20) the gaseous mixture (21) is supplied. The gaseous mixture will flow upwards and be subjected to a quenching step. The quenching step is performed in a packed bed (22) through which the gaseous mixture flows upwardly and a liquid mixture of hydrocarbons (26) flows counter-currently and thus downwardly. The resulting rich quenching liquid (26a) is cooled in heat exchanger (23) against evaporating boiler feed water and pumped by pump (25) to be partly, as part (27a), used as the liquid mixture of hydrocarbons (26) and partly be discharged via flow (27) to a residue storage vessel (28). In residue storage vessel the residue is heated to avoid solidification by means of indirect steam heater (29). The liquid residue may be discharged from the process via flow (30).

From the upper end of the vacuum distillation column (20) an overhead stream (31) is discharged and cooled in heat exchanger (32) wherein the gas oil fraction condenses. This liquid fraction is separated from the gaseous hydrocarbons boiling below the gas oil range in a gas-liquid separator (33). The overhead gas (34) as obtained and comprising hydrogen, fuel gas compounds and a naphtha fraction and a liquid gas oil fraction is compressed by compressor (35) and sent to a separation train (not shown) wherein for example a liquid naphtha product may be isolated. Part of the liquid gas oil fraction (36) is returned as a reflux stream to the vacuum distillation column (20) and part (37) of the liquid gas oil fraction is obtained as the gas oil product.

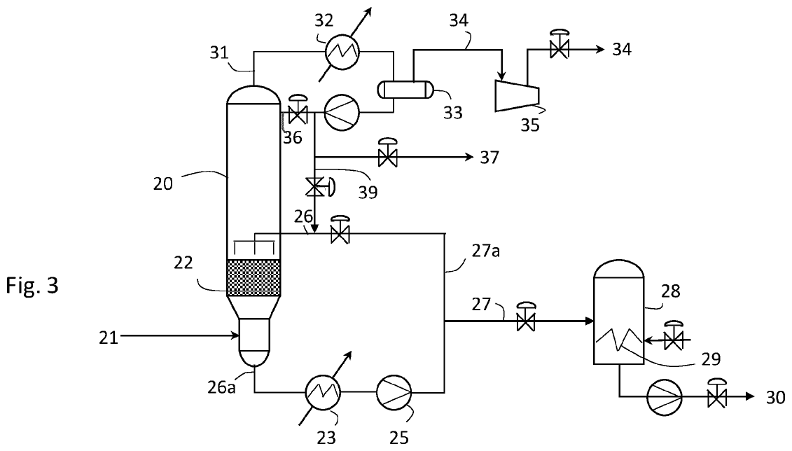

FIG. 3 shows the vacuum distillation column (20) of FIGS. 1 and 2 wherein a flow (39) is added which provides the option to use a further part of the liquid gas oil fraction in admixture with the residue to quench the gaseous mixture having an elevated temperature as it is discharged from the fluidised bed reactor.

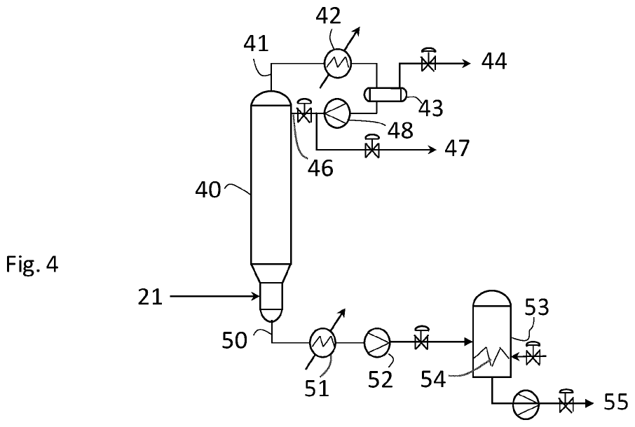

FIG. 4 shows a vacuum distillation column (40) which is not provided with a quench step. This is an alternative for the vacuum distillation column (20) of FIGS. 1 and 2. To the lower end of the vacuum distillation column (40) the gaseous mixture (21) is supplied. From the upper end of the vacuum distillation column (40) an overhead stream (41) is discharged and cooled in heat exchanger (42) wherein the gas oil fraction condenses. This liquid fraction is separated from the gaseous hydrocarbons boiling below the gas oil range in a gas-liquid separator (43). The overhead gas (44) as obtained and comprising hydrogen, fuel gas compounds and a naphtha fraction and a liquid gas oil fraction is sent to a separation train (not shown) wherein for example a liquid naphtha product may be isolated. Part of the liquid gas oil fraction (46) is returned via pump (48) as a reflux stream to the vacuum distillation column (40) and part (47) of the liquid gas oil fraction is obtained as the gas oil product.

A residue 50 is discharged at the lower end of the vacuum distillation column (40) and cooled in heat exchanger (51) against evaporating boiler feed water and pumped by pump (52) to a residue storage vessel (53). In residue storage vessel the residue is heated to avoid solidification by means of indirect steam heater (54). The liquid residue may be discharged from the process via flow (55). Note that this distillation column (40) is not provided with a reboiler.

1. A process to continuously prepare a gas oil product from carbonaceous particles of a biomass source comprising the following steps,
(a) contacting carbonaceous particles with a hydrogen comprising gas in a fluidised bed reactor in the absence of oxygen and in the absence of a catalyst, at an average solids residence time of between 20 and 120 seconds and at thermal conversion conditions to obtain a gaseous mixture comprising of hydrocarbons and char particles,
(b) discharging the char particles and the gaseous mixture separately from the fluidised bed reactor, and
(c) isolating from the gaseous mixture a gas oil product by means of distillation.

2. The process according to claim 1, wherein step (a) is performed in the absence of a porous heterogeneous catalyst onto which one or more metals of Group 6, Group 9 or Group 10 of the Table of Elements are incorporated.

3. The process according to claim 1, wherein the hydrogen comprising gas has a hydrogen content of above 25 vol. %.

4. The process according to claim 3, wherein the hydrogen comprising gas has a hydrogen content of between 50 and 75 vol. %.

5. The process according claim 1, wherein the thermal conversion conditions are achieved by contacting the carbonaceous particles with a hydrogen comprising gas at a temperature of between 50° and 1300° C. and at a pressure of between 0.7 kPa and 13.7 kPa.

6. The process according to claim 1, wherein the fluidised bed reactor comprises a bubbling fluidising bed of the carbonaceous particles to which fluidising bed the hydrogen comprising gas is supplied from below the fluidising bed as a fluidising gas and from which fluidising bed the gaseous mixture is discharged upwardly and away from the fluidising bed.

7. The process according to claim 6, wherein the char particles are discharged from the bubbling fluidising bed of the carbonaceous particles.

8. The process according to claim 1, wherein the hydrogen comprising gas has a temperature of between 100° and 1500° C.

9. The process according to claim 1, wherein in step (c) the gaseous mixture having an elevated temperature as it is discharged from the fluidised bed reactor is quenched with a liquid mixture of hydrocarbons having a lower temperature than the gaseous mixture.

10. The process according to claim 1, wherein step (c) is performed by means of vacuum distillation wherein
(i) a residue stream is discharged at a lower end of a vacuum operated distillation column and an overhead stream is discharged at an upper end of the vacuum operated distillation column,
(ii) wherein the overhead stream is cooled such that substantially the hydrocarbons boiling in the gas oil range and above condense and the hydrocarbons boiling below the gas oil range remain gaseous,
(iii) performing a gas-liquid separation thereby obtaining an overhead gas comprising hydrogen, fuel gas compounds and a naphtha fraction and a liquid gas oil fraction and
(iv) returning part of the liquid gas oil fraction as a reflux stream to the vacuum distillation column and obtaining part of the liquid gas oil fraction as the gas oil product.

11. The process according to claim 10, wherein in (iv) a further part of the liquid gas oil fraction is used to quench the gaseous mixture having an elevated temperature as it is discharged from the fluidised bed reactor.

12. The process according to claim 11, wherein a mixture of the further part of the gas oil fraction and part of the residue stream is used to quench the gaseous mixture.

13. The process according to claim 12, wherein the quenching is performed in a packed bed or distillation trays as present in a lower part of the vacuum operated distillation column and wherein in the packed bed or distillation trays an upwardly flowing gaseous mixture is counter currently contacted with a downwardly flowing mixture of the further part of the gas oil fraction and part of the residue stream.

14. The process according to claim 13, wherein the residue stream is discharged from vacuum operated distillation column at an elevation below the packed bed and wherein part of this residue stream is mixed with the further part of the gas oil fraction to be used in the quenching and part of the residue stream is discharged as a tar fraction.

15. The process according to claim 1, wherein the distillation in step (c) is performed at an absolute pressure of between 0.7 and 145 kPa.

16. The process according to claim 1, wherein hydrogen is isolated from the gaseous mixture and wherein all or part of the hydrogen as isolated is used as the hydrogen comprising gas.

17. The process according to claim 16, wherein a fuel gas is isolated from the gaseous mixture and wherein the hydrogen comprising gas is heated in a furnace using the isolated fuel gas before the hydrogen comprising gas is used in step (a).

18. The process according to claim 1, wherein the carbonaceous particles of a biomass source are wood particles or fibrous biomass particles.

19. The process according to claim 18, wherein the wood particles have a size of between 3 and 25 mm.

20. The process according to claim 1,
wherein the gas oil product has a distillation curve which is for more than 80 wt % between 250 and 300 degrees centigrade, a T90 wt percent of between 280-350 degrees centigrade, a density of between about 0.76 and 0.85 g/cm at 15 degrees centigrade, a cetane number greater than 40, a sulphur content of less than 100ppmw, a viscosity between about 1.9 and 4.1 centistokes at 40 degrees centigrade and an aromatics content of no greater than 5 wt percent.

21. A process to continuously prepare a gas oil product from carbonaceous particles of a biomass source comprising the following steps,
(a) contacting carbonaceous particles with a hydrogen comprising gas in a fluidised bed reactor in the absence of oxygen and in the absence of a porous heterogeneous catalyst onto which one or more metals of Group 6, Group 9 or Group 10 of the Table of Elements are incorporated, at an average solids residence time of between 20 and 120 seconds and at thermal conversion conditions to obtain a gaseous mixture comprising of hydrocarbons and char particles,
wherein the fluidised bed reactor comprises a bubbling fluidising bed of the carbonaceous particles to which fluidising bed the hydrogen comprising gas is supplied from below the fluidising bed as a fluidising gas and from which fluidising bed the gaseous mixture is discharged upwardly and away from the fluidising bed and the char particles are discharged from the bubbling fluidising bed of the carbonaceous particles,
(b) discharging the char particles and the gaseous mixture separately from the fluidised bed reactor, and
(c) isolating from the gaseous mixture a gas oil product by means of distillation.

22. The process according to claim 21, wherein the thermal conversion conditions are achieved by contacting the carbonaceous particles with a hydrogen comprising gas at a temperature of between 50° and 1300° C. and at a pressure of between 0.7 kPa and 13.7 kPa.

23. The process according to claim 22, wherein the hydrogen comprising gas has a hydrogen content of between 50 and 75 vol. % and a temperature of between 100° and 1500° C.
